(19) United States
(12) Patent Application Publication
(10) Pub. No.: US 2008/0209117 A1
(43) Pub. Date: Aug. 28, 2008

(54) Nonvolatile RAM

(75) Inventor: Kazuhiko Kajigaya, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 12/071,247

(22) Filed: Feb. 19, 2008

(30) Foreign Application Priority Data
Feb. 22, 2007 (JP) 2007-042231

(51) Int. Cl. G06F 12/00

(52) U.S. Cl. 711/104; 711/166; 711/E12.001

(57) ABSTRACT

A nonvolatile RAM allows a read/write operation to be performed in a random manner with respect to a memory area, which is divided into a plurality of memory arrays each including a plurality of memory cells. Upon detection of an initialization signal, initialization is performed on at least one memory array, which is selected in advance. In addition, a disconnection control signal occurs so as to disconnect an access by an external device during a prescribed period for performing the initialization. The nonvolatile RAM is capable of protecting data from being irregularly read, modified, and reloaded with respect to at least one memory array, which is selected in advance, even when the nonvolatile RAM is frequently accessed by a prescribed application.

### BACKGROUND OF THE INVENTION

1. Field of the Invention

The present invention relates to nonvolatile random-access memories (RAMs), which ensure random access without losing data irrespective of power-interruption events and power-off events.

This application claims priority on Japanese Patent Application No. 2007-42231, the content of which is incorporated herein by reference.

2. Description of the Related Art

Conventionally, nonvolatile memories such as flash memories (e.g., read-only memories ensuring on-board reloading by users) are well known as nonvolatile semiconductor storages.

The conventionally-known flash memories retain data irrespective of power-off events. In order to avoid fabrication and leakage of data, which are still retained in flash memories, various types of technologies have been developed to secure protecting functions (for protecting data from being unexpectedly changed) and security functions (for inhibiting data from being read out irregularly), as follows:
Patent Document 1: Japanese Unexamined Patent Application Publication No. 2001-14871.
Patent Document 2: Japanese Unexamined Patent Application Publication No. 2005-11151.
Patent Document 3: Japanese Unexamined Patent Application Publication No. 2004-38569.
Patent Document 4: Japanese Unexamined Patent Application Publication No. 2005-202719.
Patent Document 5: Japanese Unexamined Patent Application Publication No. 2004-287541.
Patent Document 6: Japanese Unexamined Patent Application Publication No. 2005-56144.

Patent document 1 teaches a function for inhibiting data from being fabricated and leaked irrespective of a security function being released during memory access.

Patent document 2 teaches a memory card that is designed to compulsorily erase data with a limited number of password verification times, thus protecting data from being leaked by a third party not having an access priority.

Patent document 3 teaches a reloadable ROM having a function for inhibiting data from being leaked or wrongly written due to erroneous operation of security/protect functions just after a power-on event.

Patent document 4 teaches the technology which prevents high-security data from being retained permanently in a nonvolatile memory (e.g., an IC card) while data stored in a reloadable ROM (e.g., a flash memory) are erased due to power drain, thus preventing high-security data from being misused by other users.

Patent document 5 teaches the technology that performs a write operation with respect to a specific region of a reloadable ROM, thus inhibiting data from being unexpectedly changed.

Patent document 6 teaches the technology that performs initialization (or erasure) based on history data with regard to only a certain region, which may be subjected to wrong writing in a power-off duration due to restoration of a flash memory.

The aforementioned nonvolatile memories such as reloadable ROMs differ from the conventionally-known volatile memories such as static random-access memory (SRAM) and dynamic random-access memory (DRAM) in that data thereof are retained irrespective of power-off events, wherein they have functions for protecting data from being fabricated due to wrong access.

The aforementioned technologies disclosed in patent documents 1 to 6 present the prescribed structures effectively adapted to reloadable ROMs (i.e., nonvolatile memories such as flash memories), which reliably erase data before writing new data. In other words, they are effectively adapted to nonvolatile memories for retaining necessary information (e.g., program codes) in power-off events. The aforementioned nonvolatile memories need a certain voltage required for writing and erasing of data, which differs from a voltage required for reading of data, and a certain time required for reading of data in the case of writing and erasing of data.

It is expected that a system using a nonvolatile RAM, which serves as a work area and which has non-volatility and ensures high-speed read/write operations at a prescribed voltage, will be developed.

In the aforementioned system, after completion of execution of an application, it is necessary to prevent unnecessary data, which are still retained in the work area, from being wrongly read out.

The presently-known system is designed to use a volatile RAM (e.g., a DRAM and SRAM) serving as the work area; hence, data thereof automatically disappear due to a power-off event, whereby it does not need the aforementioned security function.

In contrast, when a nonvolatile RAM is used as a work area, it may be frequently accessed by other applications because intermediate data during calculations and unnecessary data (which should be erased) still remain therein; hence, the aforementioned security function adapted to the conventionally-known nonvolatile memory such as the reloadable ROM cannot be adapted to the nonvolatile RAM.

### SUMMARY OF THE INVENTION

It is an object of the present invention to provide a nonvolatile RAM that can protect data with respect to a prescribed region frequently accessed by a prescribed application.

In a first aspect of the present invention, a nonvolatile RAM (which performs a read/write operation on a memory array in a random manner) includes an initialization means (e.g., an initialization control circuit) for outputting a disconnection control signal upon reception of an initialization signal and for performing initialization on at least a prescribed part of the memory area, and an access disconnecting means (e.g., an input/output circuit) for disconnecting an access by an external device upon reception of the disconnection control signal during a prescribed period for performing the initialization.

The memory area is divided into a plurality of memory arrays, so that the initialization is performed on a prescribed memory array selected from among the memory arrays.

The nonvolatile RAM further includes a protection means (e.g., a write-protection control circuit and a read-restriction control circuit) for performing write protection and/or read restriction on the prescribed memory array irrespective of the access by the external device.

The nonvolatile RAM further includes a register (e.g., an initialization function setting register) for designating at least one memory array subjected to initialization, so that the initialization is performed on the designated memory array with reference to the register. Herein, the register retains data thereof irrespective of a power-off event.

The nonvolatile RAM further includes a power-on detection circuit for detecting a power-on event so as to output the initialization signal to the initialization means.

The nonvolatile RAM further includes a command detection means (e.g., an initialization command reading circuit) for performing detection as to whether or not an input command given from the external device matches an initialization command, wherein the initialization signal is supplied to the initialization means when the input command matches the initialization command.

Each memory array further includes a plurality of memory cells, wherein “1” or “0” is written into all the memory cells included in the prescribed memory array subjected to initialization by means of the initialization means. Each memory cell includes a resistor whose resistance varies in response to a voltage applied thereto, by which “1” or “0” is written into each memory cell.

In a second aspect of the present invention, a control method is applied to the nonvolatile RAM, which is adapted to a computer system, wherein the initialization command is supplied to the nonvolatile RAM; detection is made as to whether or not the initialization is completed; and then, upon detection of completion of the initialization, a power supply to the nonvolatile RAM is disconnected.

In a third aspect of the present invention, a semiconductor device is formed using the nonvolatile RAM, which is laminated with a processing in a single package.

In a fourth aspect of the present invention, a computer system is formed using a semiconductor device, which includes the nonvolatile RAM laminated with a microprocessor in a single package, and an input/output device.

The present invention offers outstanding technical features as follows:

The nonvolatile RAM can be used as a work memory (serving as a work area for temporarily storing intermediate data produced in calculations) for a computer system. Even when the nonvolatile RAM is frequently accessed, upon completion of one application, it is possible to reliably erase intermediate data, which are thus prevented from being unexpectedly loaded by another application. Thus, it is possible to reliably prevent data stored in the nonvolatile RAM from being irregularly leaked.

In a power-on event, the nonvolatile RAM is capable of automatically initializing a prescribed memory array (which is selected in advance) or all the memory arrays without being controlled by the external device. Since the nonvolatile RAM can prevent the stored data thereof from being irregularly leaked without requiring additional processing, it is possible to remarkably improve security.

In a power-off event, the nonvolatile RAM is capable of initializing the prescribed memory array or all the memory arrays in response to a simple command, namely, an initialization command, given from the external device. Since the nonvolatile RAM can prevent the stored data thereof from being irregularly leaked, it is possible to remarkably improve security.

### BRIEF DESCRIPTION OF THE DRAWINGS

These and other objects, aspects, and embodiments of the present invention will be described in more detail with reference to the following drawings, in which:

FIG. 1 is a block diagram showing the constitution of a nonvolatile RAM in accordance with a first embodiment of the present invention;

FIG. 2 is a flowchart showing initialization performed on the nonvolatile RAM of the first embodiment;

FIG. 3 is a block diagram showing the constitution of a nonvolatile RAM in accordance with a second embodiment of the present invention;

FIG. 4 is a flowchart showing initialization performed on the nonvolatile RAM of the second embodiment;

FIG. 5 is a block diagram showing the constitution of a nonvolatile RAM in accordance with a third embodiment of the present invention;

FIG. 6 is a circuit diagram showing the constitution of a memory array adapted to the nonvolatile RAM according to the first, second, and third embodiments;

FIG. 7 is a sectional view showing the structure of a memory array adapted to the nonvolatile RAM according to the first, second, and third embodiments;

FIG. 8 is a flowchart showing initialization performed on the nonvolatile RAM;

FIG. 9A is a sectional view showing a first applied example, in which a nonvolatile RAM is laminated with a processor in a single package (SIP);

FIG. 9B is a sectional view showing a second applied example, in which a nonvolatile RAM is laminated with a processor in a single package (SIP);

FIG. 9C is a sectional view showing a third applied example, in which plural nonvolatile RAMs are laminated with a processor in a single package (SIP);

FIG. 9D is a sectional view showing a fourth applied example, in which plural nonvolatile RAMs are laminated with a processor in a single package (POP); and

FIG. 10 is a simple block diagram showing a fifth applied example, in which the nonvolatile RAM is applied to a cellular phone.

### DESCRIPTION OF THE PREFERRED EMBODIMENTS

The present invention will be described in further detail by way of examples with reference to the accompanying drawings.

### 1. First Embodiment

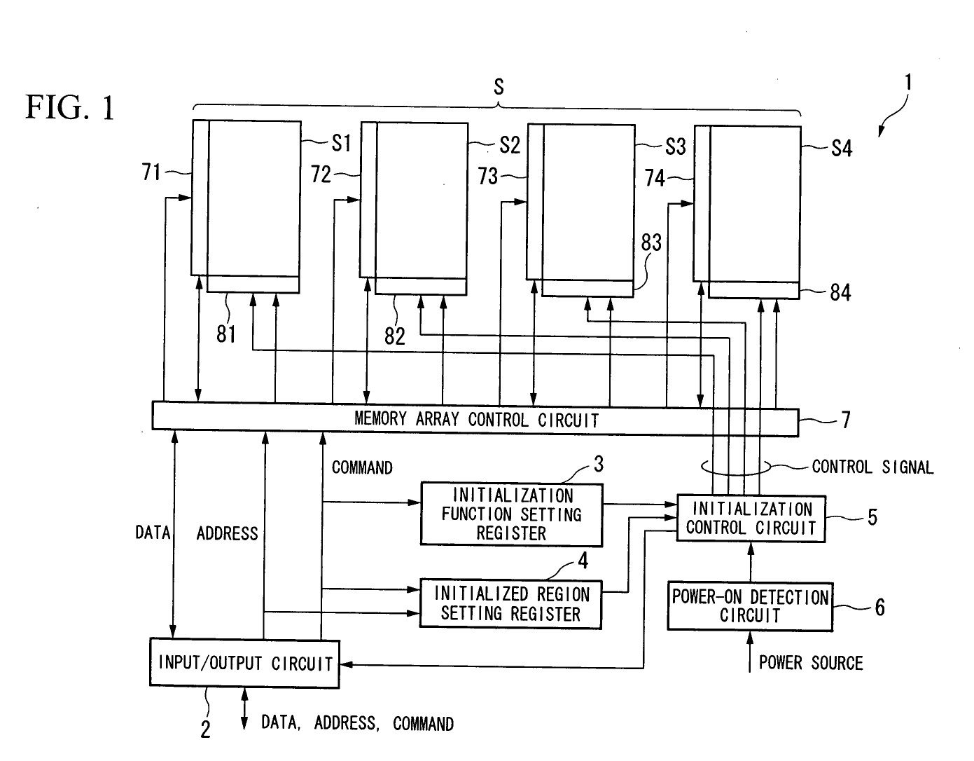

FIG. 1 is a block diagram showing the constitution of a nonvolatile RAM (or a nonvolatile memory) 1 in accordance with a first embodiment of the present invention.

The nonvolatile RAM 1 includes an input/output circuit 2, an initialization function setting register 3, an initialized region setting register 4, an initialization control circuit 5, a power-on detection circuit 6, a memory array control circuit 7, column decoders 71 to 74, and row decoders 81 to 84.

The input/output circuit 2 performs input processing on data, commands, and addresses and also performs output processing on data read from memory cells (or memory elements).

A memory area S is divided into four memory arrays S1, S2, S3, and S4, which are designated by the column decoders 71 to 74 and the row decoders 81 to 84.

The initialization function setting register 3 stores a prescribed value in response to a command given from an external device (not shown), thus making a determination as to whether to perform initialization with respect to the memory area S. For example, when “1” (or a flag) is set to the initialization function setting register 3, the initialization control circuit 5 performs initialization. When “0” (or no flag) is set to the initialization function setting register 3, the initialization control circuit 5 does not perform initialization.

The initialized region setting register 4 stores a prescribed value in response to a command given from the external device. The initialized region setting register 4 selects any one of divided memory cells, in other words, any one of the memory arrays S1, S2, S3, and S4 within the memory area S, to be subjected to initialization. Alternatively, the initialized region setting register 4 selects all the memory arrays S1-S4 to be subjected to initialization. The initialized region setting register 4 has a prescribed number of bits in correspondence with the memory arrays S1-S4 subjected to initialization, wherein “1” or “0” is set to each bit. Specifically, when “1” (or a flag) is set to a certain bit, the corresponding memory array is subjected to initialization. When “0” (or no flag) is set to a certain bit, the corresponding memory array is not subjected to initialization.

For example, when “1” is set to three bits corresponding to the memory arrays S1, S2, and S3 respectively while “0” is set to another bit corresponding to the memory array S4 in the initialized region setting register 4, the initialization control circuit 5 declares that the memory arrays S1, S2, and S3 collectively serve as a work area, while the memory array S4 is used as a region for storing fixed data (e.g., program codes).

When “1” is set to all the four bits corresponding to the memory arrays S1, S2, S3, and S4 respectively, all the memory arrays S1 to S4 collectively serve as a work area.

When the power-on detection circuit 6 detects a power-on event in which power is applied to a power terminal of the nonvolatile RAM 1 (not shown), it outputs a power-on detection signal to the initialization control circuit 5.

Upon reception of the power-on detection signal, the initialization control circuit 5 outputs a disconnection control signal to the input/output circuit 2 when it detects a flag set to the initialization function setting register 3, thus initializing each memory array in response to the setting content of the initialized region setting register 4. Upon completion of initialization with respect to one or plural memory arrays selectively subjected to initialization, the initialization control circuit 5 stops outputting the disconnection control signal to the input/output circuit 2.

In the initialization, “1” or “0” is selectively written into all the memory cells included in the memory array(s) selectively subjected to initialization. For example, when it is determined in advance that the initialization is performed by writing “1” to memory cells, the initialization control circuit 5 writes “1” into all the memory cells included in the memory array(s) subjected to initialization.

The initialization control circuit 5 stops performing initialization when it detects that no flag is set to the initialization function setting register 3.

Upon reception of a disconnection control signal from the initialization control circuit 5, the input/output circuit 2 is set to an access disconnection state (or an input disconnection state) in which data, command, and address input thereto are blocked and not supplied to the internal circuitry of the nonvolatile RAM 1 during a certain period of time for receiving the disconnection control signal.

An input command sets a read mode and the like with respect to the memory array control circuit 7, which in turn performs read/write operation on memory cells included in the memory array(s) corresponding to an input address.

The column decoders 71 to 74 select memory cells corresponding to a column address (which forms a part of the input address supplied to the memory array control circuit 7) within the memory array(s) corresponding to the input address.

The row decoders 81 to 84 selects memory cells corresponding to a row address (which forms a part of the input address supplied to the memory array control circuit 7) within the memory array(s) corresponding to the input address.

Thus, the read/write operation is selectively performed on memory cells positioned at intersecting points between columns and rows, which are designated by the column address and the row address, respectively.

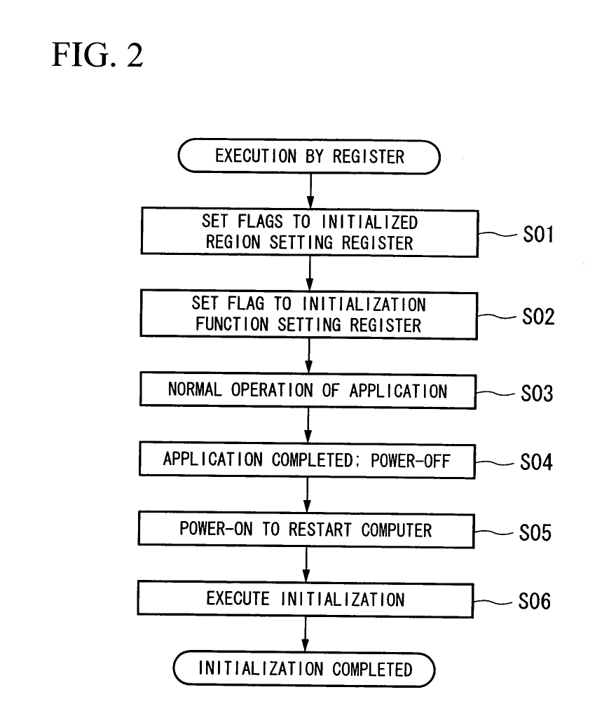

Next, the initialization of the nonvolatile RAM 1 of the first embodiment will be described with reference to FIG. 2. FIG. 2 is a flowchart showing the initialization of the nonvolatile RAM 1 of the first embodiment.

After the nonvolatile RAM 1 is mounted on a computer board (not shown), initial setting is performed in step S01 such that a microprocessor (not shown) outputs a register setting command to the initialized region setting register 4, which in turn sets a work area, i.e., the memory array(s) selectively subjected to initialization. Suppose that the microprocessor sets flags to three bits corresponding to the memory arrays S1 to S3 while not setting a flag to another bit corresponding to the memory array S4 in the initialized region setting register 4.

In step S02, initial setting is performed similar to the step S01 such that a flag indicating whether to perform initialization is set to the initialization function setting register 3 in connection with the memory array(s) selectively subjected to initialization.

In step S03, the microprocessor writes a program (initiating an application) into the memory array S4, thus allowing the user to perform the application by using the memory arrays S1 to S3 as a work area in accordance with the program.

In step S04, the user stops power supply to the computer board upon completion of the prescribed processing by way of the application.

In step S05, when the power-on detection circuit 6 detects a power-on event, it outputs a power-on detection signal to the initialization control circuit 5.

In step S06, upon detection of the power-on detection signal, the initialization control circuit 5 performs detection as to whether or not a flag is set to the initialization function setting register 3. When it is detected that the flag is set to the initialization function setting register 3, the initialization control circuit 5 outputs a disconnection control signal to the input/output circuit 2, then it starts initialization with respect to the memory arrays S1 to S3, which are selected by way of the flags set to the corresponding bits of the initialization region setting register 4.

Upon reception of the disconnection control signal, the input/output circuit 2 is set to an access disconnection state for inhibiting data, address, and command input thereto from being delivered to the internal circuitry of the nonvolatile RAM 1.

Upon completion of the initialization with respect to the memory arrays S1 to S3, the initialization control circuit 5 stops outputting the disconnection control signal.

Since the disconnection control signal is not supplied to the input/output circuit 2, the input/output circuit 2 changes the state thereof from the input disconnection state to an output state allowing data, address, and command to be delivered to the internal circuitry of the nonvolatile RAM 1.

### 2. Second Embodiment

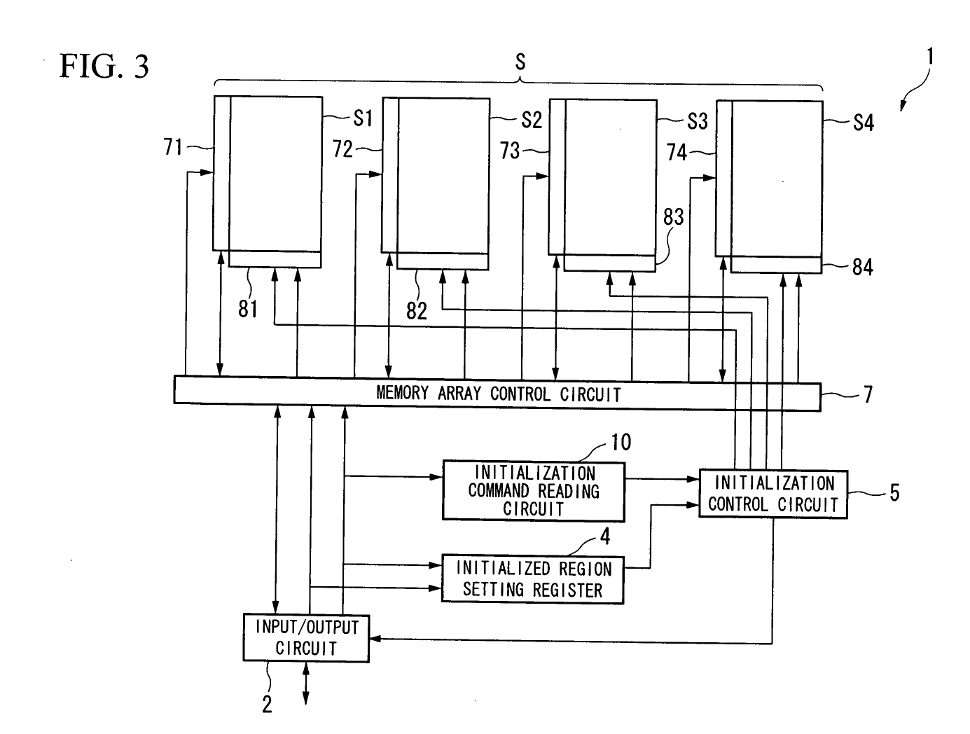

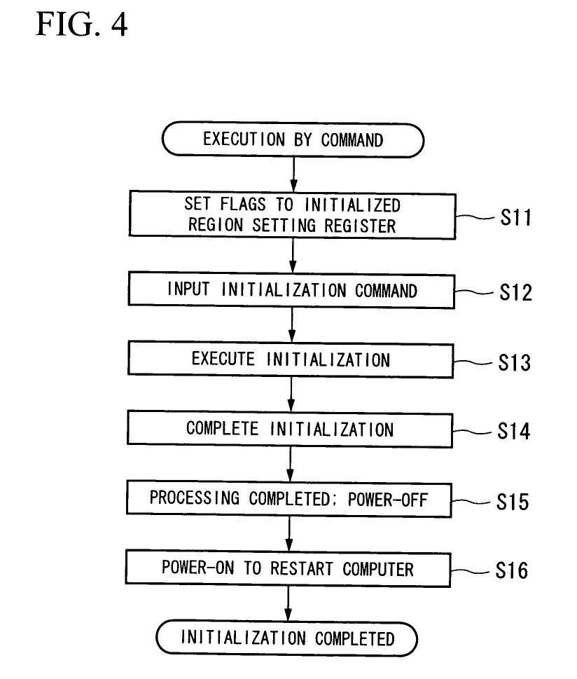

Next, a second embodiment of the present invention will be described with reference to FIGS. 3 and 4. FIG. 3 is a block diagram showing the constitution of the nonvolatile RAM 1 according to the second embodiment of the present invention, wherein parts identical to those shown in FIG. 1 are designated by the same reference numerals; hence, the duplicate description thereof will be omitted as necessary.

The nonvolatile RAM (or nonvolatile memory) 1 includes an initialization command reading circuit 10 in addition to the input/output circuit 2, the initialized region setting register 4, the initialization control circuit 5, the memory array control circuit 7, the column decoders 71 to 74, the row decoders 81 to 84, and the memory area S. The second embodiment differs from the first embodiment in that the nonvolatile RAM 1 does not have the initialization function setting register 3 and the power-on detection circuit 6 but newly includes the initialization command reading circuit 10.

The first embodiment is designed such that a flag as to whether to perform initialization is written into the initialization function setting register 3 in advance, then, the initialization control circuit 5 controls initialization, which should be performed or not on the memory area S, in a power-on event that is detected by the power-on detection circuit 6.

In contrast, the second embodiment is designed such that the initialization control circuit 5 initiates initialization upon reception of an initialization command given from an external device (not shown).

The following description will be given with respect to only the technical differences between the first embodiment and the second embodiment in connection with the nonvolatile RAM 1.

The initialization command reading circuit 10 reads an input command given from the external device so as to make detection as to whether or not the input command matches an initialization command for indicating execution of initialization.

Specifically, the initialization command reading circuit 10 reads the input command, which is given from the external device by way of the input/output circuit 2, so as to make detection as to whether or not a data string included in the input command matches a preset data string, which is stored in advance in correspondence with the initialization command. When they match each other, the initialization command reading circuit 10 detects reception of the initialization command, thus outputting an initialization control signal to the initialization control circuit 5. When they do not match each other, the initialization command reading circuit 10 does not output the initialization control signal.

Upon reception of the initialization control signal, the initialization control circuit 5 outputs a disconnection control signal to the input/output circuit 2 and also controls initialization to be performed on memory cells included in the memory array(s) registered with the initialized region setting register 4.

Upon completion of initialization on the memory array(s) selectively subjected to initialization, the initialization control circuit 5 stops outputting the disconnection control signal to the input/output circuit 2.

Next, the initialization of the nonvolatile RAM 1 of the second embodiment will be described with reference to FIG. 4. FIG. 4 is a flowchart showing the initialization of the nonvolatile RAM 1 of the second embodiment.

Step S11 of FIG. 4 is identical to the step S01 of FIG. 2; hence, the detailed description thereof will be omitted.

In step S12, when the user inputs an initialization instruction by way of an input device (e.g., a keyboard), for example, a microprocessor of a computer board (not shown) outputs an initialization command to the nonvolatile RAM 1.

The initialization command reading circuit 10 reads an input command from the input/output circuit 2; then, it makes detection as to whether or not the input command matches the initialization command.

In step S13, when the initialization command reading circuit 10 detects that the input command matches the initialization command, it outputs an initialization control signal to the initialization control circuit 5, which in turn outputs a disconnection control signal to the input/output circuit 2 and which thus starts to perform initialization on memory cells included in the memory array(s) selected by flag(s) set to the corresponding bit(s) of the initialized region setting register 4.

Upon reception of the disconnection control signal, the input/output circuit 2 is set to a input disconnection state that prevents data, address, and command input thereto from being delivered to the internal circuitry of the nonvolatile RAM 1.

In step S14, the initialization control circuit 5 stops outputting the disconnection control signal to the input/output circuit 2 upon completion of initialization with regard to the memory array(s) selectively subjected to initialization.

Since the input/output circuit 2 does not receive the disconnection control signal, it changes the state thereof from the input disconnection state to an input state in which data, address, and command input thereto are automatically delivered to the internal circuitry of the nonvolatile RAM 1.

In step S15, the user stops power supply to the computer board upon completion of the prescribed processing.

In step S16, power is applied to the computer board so as to allow other users to perform desired processing. In this case, data used by the previous user are not retained in the work area. This reliably prevents “important” intermediate data from being irregularly read by other users.

### 3. Third Embodiment

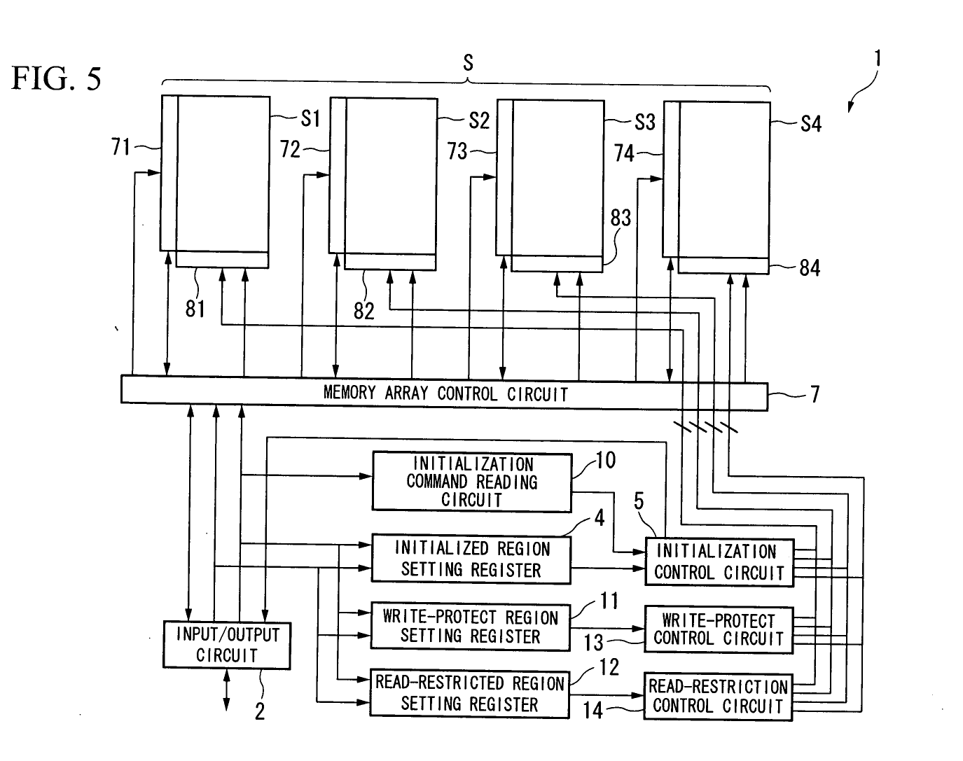

Next, a third embodiment of the present invention will be described with reference to FIG. 5. FIG. 5 is a block diagram showing the constitution of the nonvolatile RAM 1 according to the third embodiment of the present invention, wherein parts identical to those shown in FIGS. 1 and 3 are designated by the same reference numerals; hence, the duplicate description will be omitted as necessary.

The nonvolatile RAM 1 of the third embodiment includes a write-protect region setting register 11, a read-restricted region setting register 12, a write-protect control circuit 13, and a read-restriction control circuit 14 in addition to the input/output circuit 2, the initialized region setting register 4, the initialization control circuit 5, the memory array control circuit 7, the initialization command reading circuit 10, the column decoders 71 to 74, the row decoders 81 to 84, and the memory area S.

The third embodiment differs from the second embodiment in that it additionally introduces the write-protect region setting register 11, the read-restricted region setting register 12, the write-protect control circuit 13, and the read-restriction control circuit 14.

The write-protect region setting register 11 is set by a command given from an external device (not shown), wherein it selects any one of or all of the divided memory cells of the memory area S, i.e., any one of or all of the memory arrays S1 to S4, to be subjected to write protection for protecting data from being reloaded. The write-protect region setting register 11 has a prescribed number of bits corresponding to the memory arrays S1 to S4 selectively subjected to write protection, wherein “1” and “0” are respectively set to the bits so as to selectively designate the memory array(s) subjected to write protection. Specifically, when “1” (or a flag) is set to a certain bit, the corresponding memory array is subjected to write protection. When “0” (or no flag) is set to a certain bit, the corresponding memory array is not subjected to write protection.

Suppose that “0” is set to three bits corresponding to the memory arrays S1, S2, and S3 while “1” is set to another bit corresponding to the memory array S4 in the write-protection region setting register 11, for example. Thus, the memory arrays S1, S2, and S3 collectively serve as a work area, while the memory array S4 is used as an area for storing fixed data (e.g., program codes).

When “1” is set to four bits corresponding to the memory arrays S1, S2, S3, and S4 in the write-protect region setting register 11, all the memory arrays S1 to S4 are collectively used as an area for storing fixed data, which should not be changed or reloaded.

The read-restricted region setting register 12 is set by a command given from the external device, wherein it selects any one of or all of the divided memory cells of the memory area S, i.e., any one of or all of the memory arrays S1 to S4, to be subjected to read restriction for restricting data from being irregularly read out. The read-restricted region setting register 12 has a prescribed number of bits corresponding to the memory arrays S1 to S4, wherein “1” and “0” are respectively set to the bits so as to selectively designate the memory array(s) subjected to read restriction. When “1” (or a flag) is set to a certain bit, the corresponding memory array is not subjected to read restriction. When “0” (or no flag) is set to a certain bit, the corresponding memory array is subjected to read restriction.

Suppose that “0” is set to three bits corresponding to the memory arrays S1, S2, and S3 while “1” is set to another bit corresponding to the memory array S4 in the read-restricted region setting register 12, for example. In this case, the memory arrays S1, S2, and S3 collectively serve as a work area, while the memory array S4 is used as an area for storing important data, which should be restricted in irregular reading.

In order to access the memory array subjected to read restriction, a command including a password is supplied to the nonvolatile RAM 1 before performing the read operation.

Upon reception of the password of the input command, the read-restriction control circuit 14 performs detection as to whether or not a bit string included in the password matches a preset bit string. When they do not match each other, the read-restriction control circuit 14 restricts important data from being read from the memory array designated by the bit corresponding to the flag in the read-restricted region setting register 12 by way of a conventionally-known method (e.g., by deactivating the corresponding row decoder and column decoder).

When it is detected that the input password matches the preset password, the read-restriction control circuit 14 allows important data to be read from the memory array designated by the bit corresponding to the flag in the read-restriction setting register 12.

Upon detection of a write command for performing the write operation, the write-protect control circuit 13 protects data from being changed or reloaded in the memory array, which is designated by the bit corresponding to the flag in the write-protect region setting register I 1, by way of a conventionally-known method (e.g., by deactivating the corresponding row decoder and column decoder).

### 4. Constitution of Nonvolatile RAM

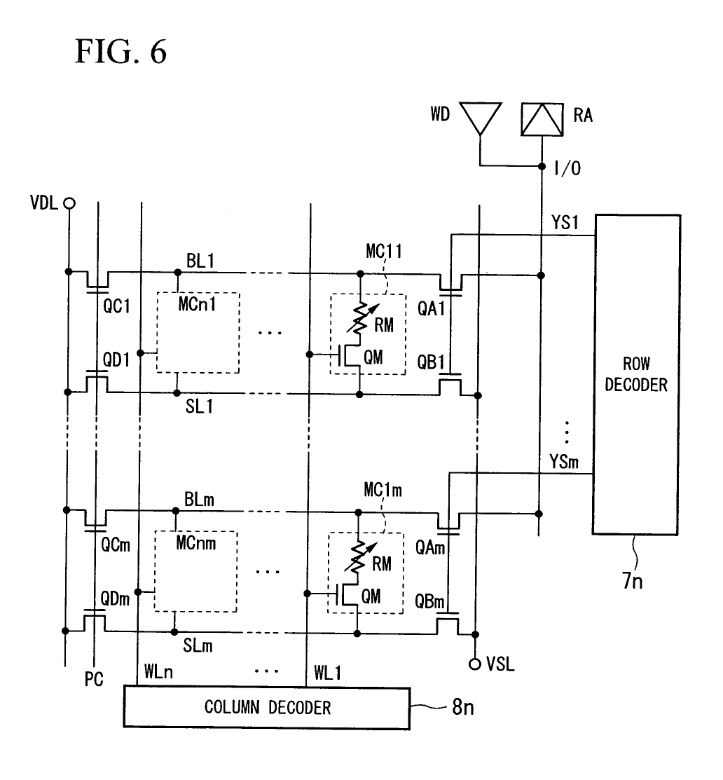

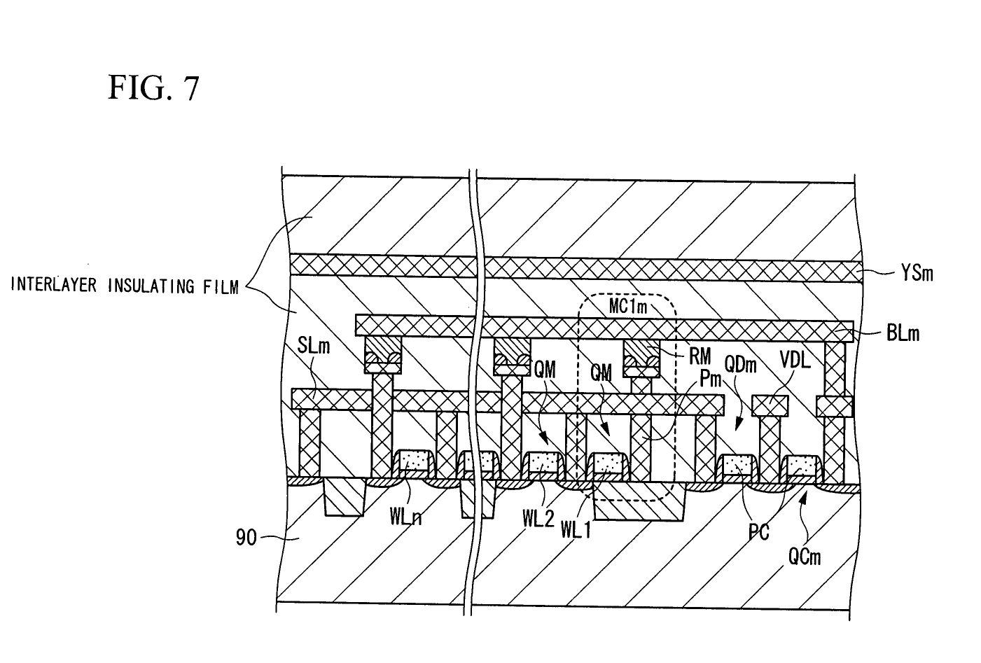

Next, the memory array adapted to the nonvolatile RAM 1 according to the first, second, and third embodiments will be described with reference to FIGS. 6 and 7, wherein the memory array is constituted of memory cells including resistors RM, each of which is a resistance variable type composed of a solid electrolyte. FIG. 6 is a circuit diagram showing the memory array including plural memory cells (designated by numerals of MC11 to MCn1, . . . , MC1m to MCnm, where “m” and “n” are integers) adapted to the nonvolatile RAM 1 having a large capacity in connection with a column decoder 7n (representing 71 to 74) and a row decoder 8n (representing 81 to 84). FIG. 7 is a sectional view showing the structure of the memory array and its peripheral portions. As described above, each of the memory cells included in the memory array is constituted using the resistor RM, which is composed of a solid electrolyte whose resistance varies due to a current flowing therethrough and which is combined with a N-channel MOS transistor QM.

In FIGS. 6 and 7, the resistor RM varies in resistance by way of the formation and disappearance of a filament due to the oxidation-reduction reaction of metal ions in the solid electrolyte.

Specifically, the resistor RM is constituted by sandwiching the solid electrolyte between a titanium electrode and a copper electrode so that the resistance thereof varies due to the movement of atoms (or ions) in the solid electrolyte (e.g., copper sulfide). When a negative voltage is applied between the titanium electrode and the copper electrode, an oxidation-reduction reaction occurs in the solid electrolyte so as to form a metal bridge in the solid electrolyte, so that the memory cell is turned on with a low resistance. When a positive voltage is applied between the titanium electrode and the copper electrode, a reverse reaction occurs so as to cause disappearance of the metal bridge, so that the memory cell is turned off with a high resistance.

In a write operation for writing data “0”, a specific memory cell subjected to the write operation is selected in such a way that a row-select signal line WL (representing WL1 to WLn) and a column-select signal YS (representing YS1 to YSn) are both set to a high level, and MOS transistors QA (representing QA1 to QAm), QB (representing QB1 to QBm), and QM are turned on. A write current (having a necessary value enabling the write operation) flows through a virtual ground line VSL from a write driver WD, thus increasing the resistance of the resistor RM included in the specific memory cell.

In a write operation for writing data “1”, a write current flows in a reverse direction (which is reverse to the aforementioned direction regarding the write operation of data “0”), that is, it flows through the virtual ground line VSL to the write driver WD, thus decreasing the resistance of the resistor RM.

In a read operation, the row-select signal line WL and the column select signal line YS are both set to a high level, and a specific memory cell subjected to the read operation is selected, wherein a read amplifier RA performs amplification and comparison between a reference current value and a detection current value applied to the virtual ground line VSL via an I/O line, thus detecting the magnitude of the resistance of the resistor RM. Herein, the resistance becomes high when the detection current value is lower than the reference current value, while the resistance becomes low when the detection current value is higher than the reference current value.

A line VDL provides a precharge voltage to a bit line BL (representing BL1 to BLm) and a source line SL (representing SL1 to SLm). By way of the line VDL, MOS transistors QC (representing QC1 to QCm) and QD (representing QD1 to QDm) are turned on at a high level of a line PC in connection with the memory cells before the read operation, so that the bit line BL and the source line SL are set to the same potential, thus precharging memory cells.

After completion of precharge, the line PC becomes a low level so that the MOS transistors QC and QD are turned off, whereby the bit line BL and the source line SL are placed in a floating state with respect to the line VDL. Herein, no current flows through the other memory cells connected to the same bit line BL and the same source line SL as the specific memory cell is selected by the row-select signal line WL and the column-select signal line YS because the MOS transistors QM for selecting the memory cells are turned off. This reliably prevents data from being irregularly read out and reloaded.

The row-select signal line WL is activated by the row decoder 8n decoding an input row address, and the column-select signal line YS is activated by the column decoder 7n decoding an input column address.

Each of the memory cells is capable of reading and reloading data within several tens of nano-seconds. The memory cells differ from the conventionally-known flash memories in that they do not need to erase data before reloading, and they do not need reloading verification; hence, they can be each used as RAM serving as a work memory.

With reference to FIG. 7, diffusion layers serving as sources and drains as well as gate electrodes are formed on a substrate 90 so as to form the MOS transistors QA, QB, QC, QD, and QM. In addition, multiple wiring layers are formed via insulating films so as to form the column-select signal line YS, the bit line BL (and line VDL), and the row-select signal line WL (and line PC).

With respect to the memory cell MC1m, the resistor RM is formed between a plug Pm, which is connected to the drain of the MOS transistor QM, and the bit line BLm

### 5. Initialization of Nonvolatile RAM

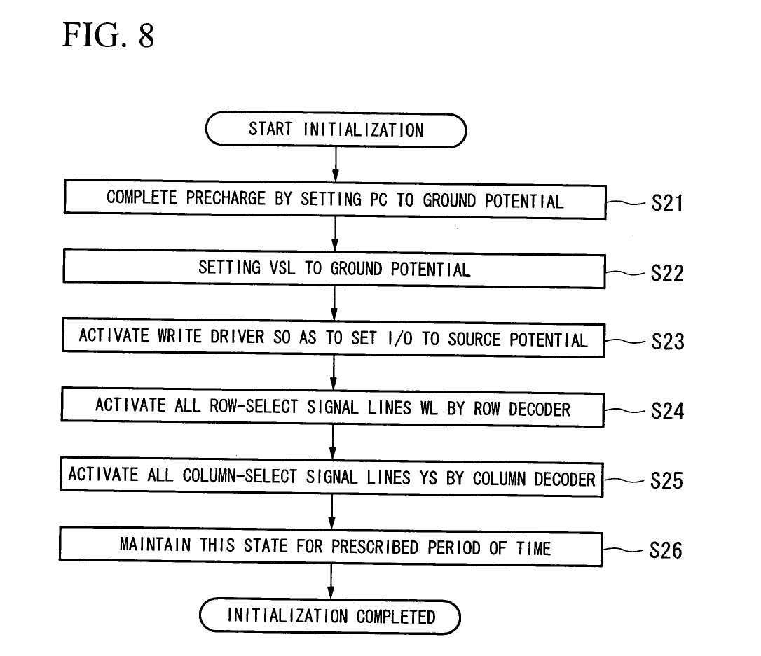

An initialization of the nonvolatile RAM 1 will be described with reference to FIGS. 6 and 8. FIG. 8 is a flowchart showing the initialization of the nonvolatile RAM 1 according to the first, second, and third embodiments.

Prior to the initialization, the initialization control circuit 5 completes precharging of the bit line BL and the source line SL, both of which are thus placed in a floating state with respect to the VDL in step S21. At this time, all the row-select signal lines WL and the column-select signal lines YS are set to a low level.

Next, the virtual ground line VSL is set to a ground potential in step S22. Then, the write driver WD is activated so as to set the I/O line to a source potential in step S23.

After the virtual ground line VSL reaches the ground potential while the I/O line reaches the source potential, all the row-select signal lines WL are set to a high level, thus turning on the MOS transistors QM in step S24.

Next, all the column-select signal lines YS are set to a high level, thus turning on all the MOS transistors QA and QB in step S25.

The aforementioned state is retained for a prescribed period of time so that data “0” is simultaneously written into the resistors RM included in all memory cells, which are thus initialized at a high resistance in step S26. A current value required for the initialization ranges from several micro-amperes to several tens of micro-amperes (μA) with respect to each memory cell. In order to perform initialization on a large memory area (i.e., memory arrays having numerous memory cells), memory arrays are divided into blocks, each of which includes one-thousand memory cells to ten-thousands memory cells, wherein initialization is sequentially performed in series with respect to the blocks.

Unlike the conventionally-known flash memories, the memory cells do not need to reload data by way of temporary erasure of data. Similar to DRAM and SRAM, the memory cells are capable of performing random access on a random address, thus realizing high-speed reloading of data. Even when the memory arrays are divided into blocks subjected to initialization in series, one second or less may be required to perform initialization with respect to the memory area of one giga-bits; hence, the nonvolatile RAM 1 has practicability.

In addition, the memory cells differ from the conventionally-known flash memories in that they do not need booster power and erasure verification. This makes it possible to immediately perform initialization on memory cells just after power is applied to the nonvolatile RAM 1.

### 6. Application of Nonvolatile RAM

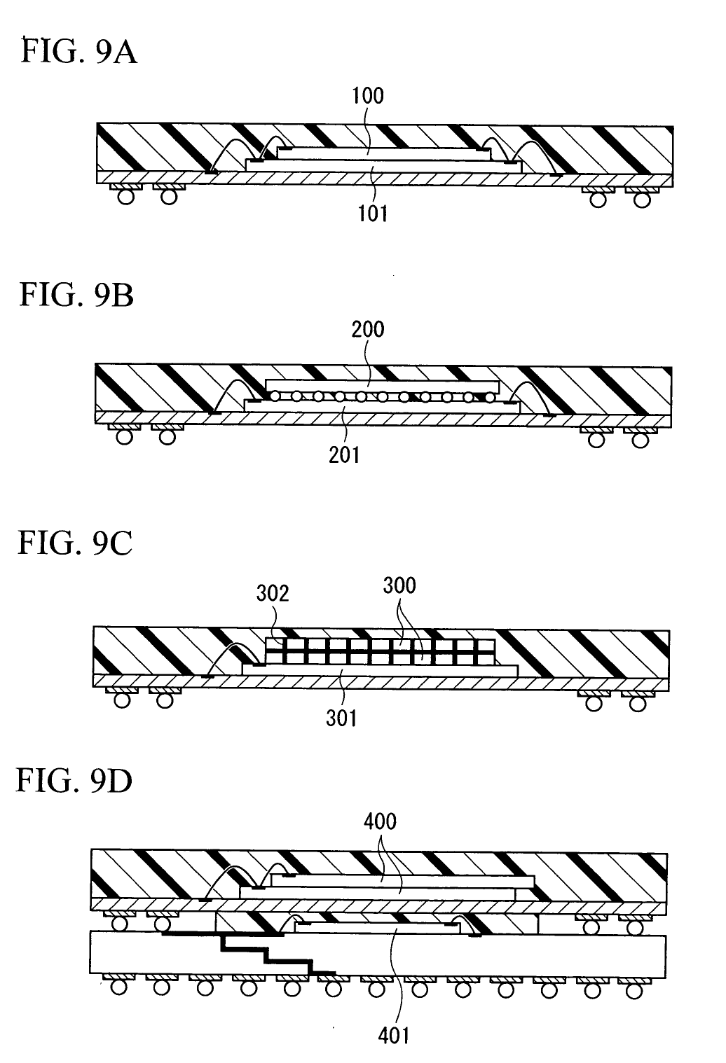

Next, applied examples of nonvolatile RAMs applied to portable small-size electronic devices will be described with reference to FIGS. 9A to 9D. FIGS. 9A to 9D are sectional views showing the structures of packages including nonvolatile RAMs and processors.

Each of FIGS. 9A to 9C shows a single package in which at least one nonvolatile RAM is laminated with an LSI chip serving as a processor by way of SIP (System In Package).

Specifically, FIG. 9A shows a first applied example in which a nonvolatile RAM 100 is laminated with an LSI chip 101 (serving as a processor) in a single package such that electrode pads thereof are electrically connected to a substrate via bonding wires. FIG. 9B shows a second applied example in which a nonvolatile RAM 200 is laminated with an LSI chip 201 (serving as a processor) in a single package such that electrode pads thereof join together via micro solder balls. FIG. 9C shows a third applied example in which plural nonvolatile RAMs 300 are laminated together in a single package such that they are connected together via silicon through-electrodes 302 for establishing connection with electrodes of an LSI chip 301 (serving as a processor). FIG. 9D shows a fourth applied example in which two large-capacity nonvolatile RAMs 400 are laminated together in a single package, which is combined with a package including a processor 401, thus forming a single electronic component.

Due to the aforementioned packaging shown in FIGS. 9A to 9D, it is possible to reduce the total mount area for mounting the nonvolatile RAM and the LSI chip on a computer board. This reduces the size and the manufacturing cost with respect to portable small-size electronic devices such as cellular phones.

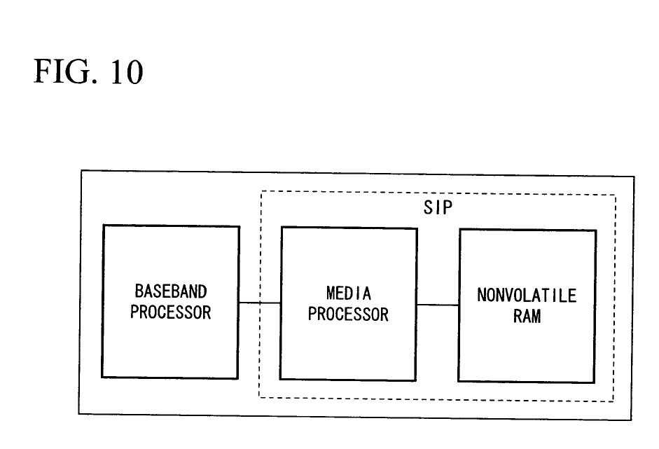

FIG. 10 is a block diagram showing a fifth modified example, in which the nonvolatile RAM according to the foregoing embodiments is installed in a cellular phone system. As described above, the nonvolatile RAM has an initialization function for performing initialization on a prescribed area (or a prescribed memory array), which is selected in advance, as well as a write-protect function and/or a read-restriction function performed with respect to the other area (or other memory arrays), which is not subjected to initialization. The nonvolatile RAM 1 is combined with a media processor in a single package (SIP) as shown in FIGS. 9A to 9C and is combined with a baseband processor for use in the cellular phone system.

The nonvolatile RAM and the LSI chip are sealed in a single package, which is combined with another package including the baseband processor. This simplifies the system of a computer board, which can be thus reduced in size. Thus, it is possible to reduce the system scale and the manufacturing cost.

The nonvolatile RAM has a security function, which reliably prevents data from being irregularly leaked or modified even when a portable small-size electronic device such as a cellular phone including the nonvolatile RAM is lost.

Lastly, the present invention can be further modified in a variety of ways within the scope of the invention as defined in the appended claims.

What is claimed is:

1. A nonvolatile RAM for performing a read/write operation on a memory area in a random manner, comprising:
an initialization means for outputting a disconnection control signal upon reception of an initialization signal and for performing initialization on at least a prescribed part of the memory area; and
an access disconnecting means for disconnecting an access by an external device upon reception of the disconnection control signal during a prescribed period for performing the initialization.

2. A nonvolatile RAM according to claim 1, wherein the memory area is divided into a plurality of memory arrays, so that the initialization means performs the initialization on a prescribed memory array selected from among the plurality of memory arrays.

3. A nonvolatile RAM according to claim 2 further comprising a protection means for performing write protection and/or read restriction on the prescribed memory array irrespective of the access by the external device.

4. A nonvolatile RAM according to claim 2, wherein the initialization means includes a register for designating at least one memory array subjected to the initialization, so that the initialization is performed on the designated memory array with reference to the register.

5. A nonvolatile RAM according to claim 4, wherein the register retains data thereof irrespective of a power-off event.

6. A nonvolatile RAM according to claim 1 further comprising a power-on detection circuit for detecting a power-on event so as to output the initialization signal to the initialization means.

7. A nonvolatile RAM according to claim 1 further comprising a command detection means for performing detection as to whether or not an input command given from the external device matches an initialization command, wherein the initialization signal is supplied to the initialization means when the input command matches the initialization command.

8. A nonvolatile RAM according to claim 2, wherein each of the memory arrays includes a plurality of memory cells, and wherein “1” or “0” is written into all the memory cells included in the prescribed memory array subjected to initialization by means of the initialization means.

9. A nonvolatile RAM according to claim 8, wherein each of the memory cells includes a resistor whose resistance varies in response to a voltage applied thereto, by which “1” or “0” is written into each of the memory cells.

10. A control method for a nonvolatile RAM adapted to a computer system, wherein the nonvolatile RAM includes an initialization means for outputting a disconnection control signal upon reception of an initialization signal and for performing initialization on at least a prescribed part of a memory area, an access disconnecting means for disconnecting an access by an external device upon reception of the disconnection control signal during a prescribed period for performing the initialization, and a command detection means for performing detection as to whether or not an input command given from the external device matches an initialization command, in which the initialization signal is supplied to the initialization means when the input command matches the initialization command,
said control method comprising the steps of:
supplying the initialization command to the nonvolatile RAM;
detecting whether or not the initialization is completed; and
upon detection of completion of the initialization, disconnecting a power supply to the nonvolatile RAM.

11. A semiconductor device comprising:
a nonvolatile RAM, which includes an initialization means for outputting a disconnection control signal upon reception of an initialization signal and for performing initialization on at least a prescribed part of a memory area, and an access disconnecting means for disconnecting an access by an external device upon reception of the disconnection control signal during a prescribed period for performing the initialization; and
a processor that is laminated with the nonvolatile RAM in a single package.

12. A semiconductor device according to claim 11, wherein the memory area is divided into a plurality of memory arrays, so that the initialization means performs the initialization on a prescribed memory array selected from among the plurality of memory arrays.

13. A semiconductor device according to claim 12, wherein the nonvolatile RAM further includes a protection means for performing write protection and/or read restriction on the prescribed memory array irrespective of the access by the external device.

14. A semiconductor device according to claim 12, wherein the initialization means includes a register for designating at least one memory array subjected to the initialization, so that the initialization is performed on the designated memory array with reference to the register.

15. A semiconductor device according to claim 14, wherein the register retains data thereof irrespective of a power-off event.

16. A semiconductor device according to claim 11, wherein the nonvolatile RAM further includes a power-on detection circuit for detecting a power-on event so as to output the initialization signal to the initialization means.

17. A semiconductor device according to claim 11, wherein the nonvolatile RAM further includes a command detection means for performing detection as to whether or not an input command given from the external device matches an initialization command, wherein the initialization signal is supplied to the initialization means when the input command matches the initialization command.

18. A semiconductor device according to claim 12, wherein each of the memory arrays includes a plurality of memory cells, and wherein “1” or “0” is written into all the memory cells included in the prescribed memory array subjected to initialization by means of the initialization means.

19. A semiconductor device according to claim 18, wherein each of the memory cells includes a resistor whose resistance varies in response to a voltage applied thereto, by which “1” or “0” is written into each of the memory cells.
